(19) United States
(12) Patent Application Publication
(10) Pub. No.: US 2022/0317705 A1
(43) Pub. Date: Oct. 6, 2022

(54) AIRCRAFT RETURN CONTROL METHOD AND DEVICE, AIRCRAFT AND STORAGE MEDIUM

(71) Applicant: Autel Robotics Co., Ltd., Shenzhen (CN)

(72) Inventor: Tianbao Zhang, Shenzhen (CN)

(21) Appl. No.: 17/659,690

(22) Filed: Apr. 19, 2022

Related U.S. Application Data
(63) Continuation of application No. PCT/CN2020/122544, filed on Oct. 21, 2020.

(30) Foreign Application Priority Data
Oct. 21, 2019 (CN) 201911001438.0

(51) Int. Cl. G05D 1/06; G05D 1/08; G05D 1/10; G05D 1/00; G06V 10/75; G06V 20/17; G01S 13/36; B64C 39/02

(52) U.S. Cl. CPC G05D 1/0676; G05D 1/0816; G05D 1/101; G05D 1/0022; G06V 10/759; G06V 20/17; G01S 13/36; B64C 39/024; B64C 2201/127; B64C 2201/145; B64C 2201/146; B64C 2201/18

(57) ABSTRACT

The embodiments are an aircraft return control method and device, an aircraft and a storage medium. The method includes: determining the location of a return target region according to the time and the phase of a return signal; and when flying to the return target region, according to a matching result between an image of a current region and a pre-collected image of the return target region, adjusting flight parameters to land at the return target. Embodiments of the present invention solve the technical problem in the prior art that the aircraft cannot be accurately landed at the return target due to the movement of the return target, and achieve the technical effect of controlling the aircraft to accurately and safely land at the return target on the return target region.

### CROSS REFERENCE

The present application is a continuation of International Application No. PCT/CN2020/122544, filed on Oct. 21, 2020, which claims priority to Chinese patent application No. 201911001438.0, filed on Oct. 21, 2019, which is incorporated herein by reference in its entirety.

### TECHNICAL FIELD

Embodiments of the present invention relate to an aircraft technology, and in particular to an aircraft return control method and device, an aircraft and a storage medium.

### RELATED ART

With the continuous development of science and technology, the application fields of aircraft (such as UAV) are becoming more and more extensive. For example, the UAV is used in the fields of express transportation, street scene shooting and monitoring inspection.

Generally speaking, the destination location of UAV return is fixed. However, if the UAV needs to be parked on a non-stationary plane such as a yacht or ship, the location of the UAV is not fixed because mobile vehicles such as the yacht and the ship sail at sea. Therefore, how to ensure that the UAV can safely land on the mobile vehicles such as the yacht and the ship to avoid falling into the water is an urgent problem to be solved.

### SUMMARY

The present invention provides an aircraft return control method and device, an aircraft and a storage medium, so as to ensure that the aircraft can accurately and safely land at a return destination on a return target in a moving state.

In a first aspect, embodiments of the present invention provide an aircraft return control method, including:

determining the location of a return target region according to the time and the phase of a return signal;

when flying to the return target region, according to a matching result between an image of a current region and a pre-collected image of the return target region, adjusting flight parameters to land at the return target.

In a second aspect, embodiments of the present invention further provide an aircraft return control device, including:

a first determining module, used for determining the location of a return target region according to the time and the phase of a return signal;

a first control module, used for adjusting flight parameters according to a matching result between an image of a current region and a pre-collected image of the return target region when flying to the return target region, to land at the return target.

In a third aspect, embodiments of the present invention further provide an aircraft, including:

one or a plurality of processors;

a memory, used for storing one or more programs;

an image shooting unit, used for shooting images;

When the one or more programs are executed by the one or a plurality of processors, the one or plurality of processors implement the aircraft return control method according to the first aspect.

In a fourth aspect, embodiments of the present invention further provide a computer-readable storage medium on which computer programs are stored, and when the programs are executed by a processor, the aircraft return control method according to the first aspect is implemented.

The present invention roughly calculates the location of the return target region according to the time and the phase of the return signal, so as to ensure that the aircraft can return to the location above the return target region. When the aircraft flies to the return target region, according to the matching result between the image of the current region and the pre-collected image of the return target region, the flight parameters are adjusted to land at the return target. The present invention solves the technical problem in the prior art that the aircraft cannot be accurately landed at the return target due to the movement of the return target, and achieves the technical effect of controlling the aircraft to accurately and safely land at the return target on the return target region.

### BRIEF DESCRIPTION OF THE DRAWINGS

FIG. 1 is a schematic diagram of an application scenario of an aircraft return control method provided by an embodiment of the present invention;

FIG. 2 is a schematic diagram of display of a yacht mode switch provided by an embodiment of the present invention;

FIG. 3 is a schematic diagram of display of a yacht mode warning dialog box provided by an embodiment of the present invention;

FIG. 4 is a schematic diagram of selection of a post-take-off action provided by an embodiment of the present invention;

FIG. 5 is a schematic diagram of display of setting a return point provided by an embodiment of the present invention;

FIG. 6 is a flow chart of an aircraft return control method provided by an embodiment of the present invention;

FIG. 7 is a schematic diagram of display of controlling an aircraft to accurately land at a return target provided by an embodiment of the present invention;

FIG. 8 is a flow chart of another aircraft return control method provided by an embodiment of the present invention;

FIG. 9 is a flow chart of another aircraft return control method provided by an embodiment of the present invention;

FIG. 10 is a flow chart of return control during landing of an aircraft provided by an embodiment of the present invention;

FIG. 11 is a flow chart of another return control during landing of an aircraft provided by an embodiment of the present invention;

FIG. 12 is a flow chart of an aircraft return control method when GPS signals of an aircraft and a remote control terminal are good provided by an embodiment of the present invention;

FIG. 13 is a flow chart of an aircraft return control method when GPS signals of an aircraft and a remote control terminal are bad provided by an embodiment of the present invention;

FIG. 14 is a structural block diagram of an aircraft return control device provided by an embodiment of the present invention; and

FIG. 15 is a schematic diagram of a hardware structure of an aircraft provided by an embodiment of the present invention.

### DETAILED DESCRIPTION

The present invention will be further described in detail below in conjunction with the drawings and embodiments. It should be understood that the specific embodiments described herein are only used to explain the present invention, but not to limit the present invention. In addition, it should be noted that, for the convenience of illustration, the drawings only show some but not all of structures related to the present invention.

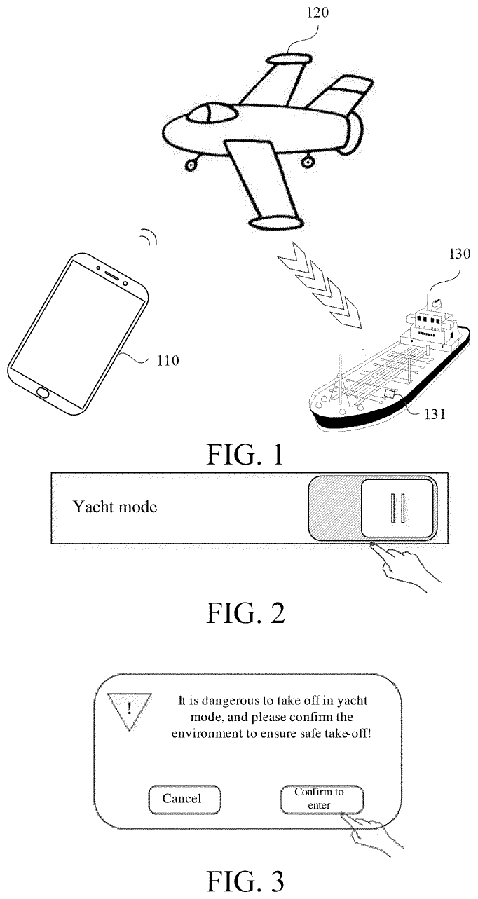

It should be noted here that an aircraft return control method provided by an embodiment of the present invention may be applied to a scenario where a return target region is a moving target region. The moving target region may be a moving target such as a yacht, a cruise ship and a car. FIG. 1 is a schematic diagram of an application scenario of an aircraft return control method provided by an embodiment of the present invention. As shown in FIG. 1, a remote control terminal 110 may send wireless control commands (such as, return commands, hover commands and take-off commands) to an aircraft 120 through a wireless network. After the aircraft 120 receives the wireless control command, the aircraft performs the corresponding flight operation according to the wireless control command. For example, after the aircraft 120 receives the return instruction, the aircraft responds to the return instruction and flies to a return target 131 in a preset return target region 130.

The remote control terminal 110 may be a remote controller configured with a display device, or may be a mobile terminal provided with an aircraft control application (APP). The mobile terminal may be a smart phone, a tablet personal computer, an iPad and a notebook computer. In the embodiment, the remote control terminal 110 is a smart phone provided with an aircraft control APP, and the return target region is a yacht as an example to describe the aircraft return control method. Exemplarily, a yacht mode switch can be set in the APP, and of course, other modes can also be set, which is not limited, as long as the return target is in a moving state, so that the location of the return target region changes. FIG. 2 is a schematic diagram of display of a yacht mode switch provided by an embodiment of the present invention. As shown in FIG. 2, a trigger button is arranged on the right side of the yacht mode switch, and a user can enter the yacht mode or exit the yacht mode by clicking the trigger button.

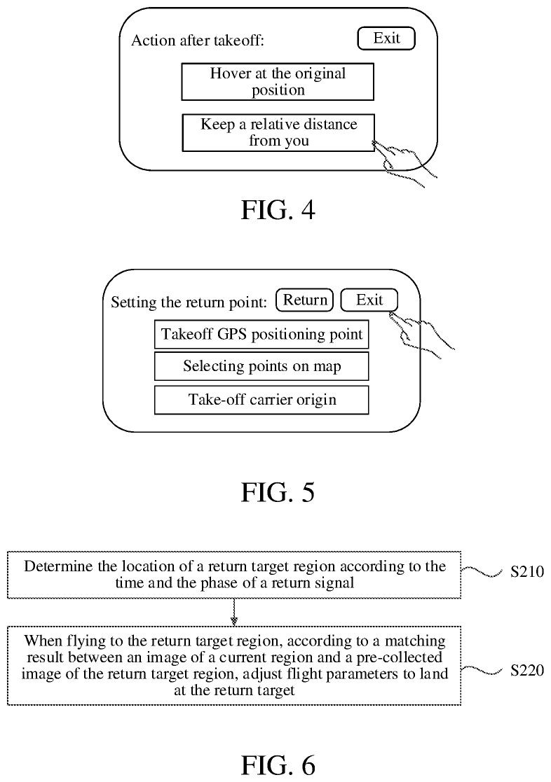

When the user turns on the yacht mode switch, a yacht mode warning dialog box will pop up on a display interface of the mobile terminal. FIG. 3 is a schematic diagram of display of the yacht mode warning dialog box provided by an embodiment of the present invention. As shown in FIG. 3, the yacht mode warning dialog box displays “It is dangerous to take off in yacht mode, and please confirm the environment to ensure safe take-off!”. Moreover, two buttons are arranged under the dialog box, namely “cancel” and “confirm to enter”. If the user clicks the “cancel” button, the default interface and normal take-off mode will be restored, and the aircraft cannot be unlocked and taken off on a non-stationary plane such as a yacht. If the user clicks the “confirm to enter” button, a dialog box for actions after takeoff will pop up. FIG. 4 is a schematic diagram of selection of a post-take-off action provided by an embodiment of the present invention. As shown in FIG. 4, two selection buttons “hover at the original position” and “keep a relative distance from you” are displayed on the dialog box for actions after takeoff. After the user selects any one of the modes, a dialog box of “setting the return point” pops up on the display interface of the mobile terminal. FIG. 5 is a schematic diagram of display of setting a return point provided by an embodiment of the present invention. It should be noted that each aircraft is provided with a satellite navigation module, that is, a global positioning system (GPS). It can be understood that the aircraft can be positioned through GPS. As shown in FIG. 5, three options of “takeoff GPS positioning point”, “selecting points on map” and “takeoff carrier” are set on the dialog box of setting the return point. The user can select any one of the modes according to own needs, and then can click the “start” button. At this time, the aircraft can be unlocked and taken off on a non-stationary plane such as a yacht. Of course, at this time, the user can also click the “exit” button to exit the setting of the yacht mode; and the user can also click the “return” button to return to the setting page of the previous item.

As shown in FIG. 4, if the user selects “hover at the original position”, the aircraft hovers in an inertial coordinate system after take-off, and the user uses the remote controller of the aircraft to operate the stick, and the flight speed in the inertial frame is changed. If the user selects “stay relatively still with you”, the aircraft maintains a relative translation relationship with the user after take-off, that is, the distance between the user and the aircraft remains unchanged, and the user uses the remote controller to operate the stick to change the speed of the aircraft relative to a moving coordinate system (user). However, in this action, when the altitude of the aircraft is greater than 10 m, the aircraft exits the relatively static flight mode and switches to fly in the inertial frame.

In FIG. 5, if the user selects the return point as the “takeoff GPS positioning point”, the aircraft will return to land at the GPS positioning point at the time of take-off. Since this mode is dangerous, the user needs to be prompted with a dialog box of “may fall into the water, please confirm”. If the user selects the return point as “selecting points on the map”, the display interface of the mobile terminal is switched to a map interface, to allow the user to take a point on the map, and a dialog box of “confirming whether the selected point is suitable for landing” pops up. If the user selects the return point as “takeoff carrier”, a dialog box “the aircraft will land at the original takeoff point on the deck, and the vision needs to be started to ensure accurate landing” pops up. After the user selects to confirm, the aircraft will fly to the location above the yacht/cruise ship when returning, and a downward vision is started to accurately land on the deck during takeoff. The downward vision refers to an image shooting unit, on the aircraft, which can shoot images of the position below the aircraft.

Of course, in order to ensure the flight safety of the aircraft, after the aircraft is powered off and turned on each time, the default is a normal take-off mode, that is, the yacht mode is in a closed state. Three modes of setting the return points will now be described in detail.

In one embodiment, when the user sets the return point as the “takeoff GPS positioning point”. When the aircraft receives a take-off command, the GPS latitude and longitude of the location where the aircraft takes off may be recorded. When returning, the aircraft flies to the location above the take-off point to land. However, at this time, a mobile vehicle possibly moves away, and the aircraft easily falls in the water. Therefore, this function needs to add the prompt “use this function with caution, and make sure that the take-off origin is suitable for landing, otherwise it is likely to fall into the water!”.

In order to ensure safety, if this function is triggered, the aircraft controls itself to fly above the original take-off point, and descends to a height of 10 m, and the vision is turned on to find a characteristic region that matches the image at the time of take-off. If a matching characteristic region is found, the aircraft is expanded for accurate landing, descends slowly and adjusts own position until the aircraft lands on the deck at take-off. If no matching characteristic region is found, the aircraft is in a hovering state, and sends a warning command to the remote control terminal to request to reset the return point.

In one embodiment, the user sets the return point as “selecting points on the map”. When the user clicks “selecting points on the map” button as shown in FIG. 5, the display interface of the mobile terminal can be switched to the map interface, and the user can select a point on the map as the return point. The aircraft recognizes the points selected by the user according to a satellite map. When the points selected by the user are rivers, oceans, forests, etc., the user is prompted with “this is not suitable for landing, and please select again”. If the user selects others such as buildings, squares, etc., the aircraft is prompted with “please ensure the safety of the landing point, and are you sure to select this as the return point?”, and the user can choose “Yes” or “No”. When the user selects “Yes”, the aircraft will take the selected point on the map as the return target. Whether it is the user key to return or low power return, the aircraft will land to the selected point.

In one embodiment, the user sets the return point as the “take-off carrier origin”. Exemplarily, it is assumed that the user operates the aircraft on a yacht, and the yacht drives away at this time. The aircraft can still return to the return target region on the yacht, and accurately land on the deck at the time of takeoff (i.e., the return target), so as not to fall into the water or fly away. The embodiments of the present invention describe the aircraft return control method when the return point is set as the “takeoff carrier origin”, so as to ensure that the aircraft can accurately land on the return target located in the moving return target region.

FIG. 6 is a flow chart of an aircraft return control method provided by an embodiment of the present invention. This embodiment can be applied to the situation where the aircraft is accurately landed to the return destination at the return target in a moving state. The method can be executed by an aircraft return control device, wherein the method can be implemented by hardware and/or software, and is generally integrated in the aircraft.

Referring to FIG. 6, the method specifically includes the following steps:

S210. determining the location of a return target region according to the time and the phase of a return signal.

The return signal refers to a wireless signal when the user sends a return command to the aircraft through the remote control terminal. In an embodiment, the user can send the return command to the aircraft through the remote control terminal, and the aircraft determines the position of the return target region according to the time and the phase at which the return signal corresponding to the return command is received. The location of the return target region refers to a certain region position on the return target where the aircraft will land. Of course, in the embodiment, the location of the return target region may be a location of the return target on which the remote control terminal is located, or may be a location of the return target at which the user is. In the actual operation process, the location of the remote control terminal on the return target is the location of the user on the return target.

S220. When flying to the return target region, according to a matching result between an image of a current region and a pre-collected image of the return target region, adjusting flight parameters to land at the return target.

It should be noted here that the return target region is a region located on the return target. Considering that there are two situations in which the return target is in a moving state and a stationary state, the return target in the moving state or the stationary state will be described.

In one embodiment, when the return target where the return target region is located is in the stationary state, the aircraft returns according to the location of the return target region determined by the time and the phase of receiving the return signal, and the reached location is the location of the remote control terminal on the return target. At this time, the aircraft can return directly according to the location of the return target region. When the aircraft flies to the return target region, the aircraft has flown above the location of the remote control terminal (i.e., the user position). At this time, an image shooting unit on the aircraft (which can be a separate ground camera on the aircraft) can be started to collect the images of the downward vision location of the region where the aircraft is currently located, and the images of the downward vision location are matched with the pre-collected images of the return target region to finely adjust the flight parameters of the aircraft according to the matching result, so as to accurately land at the return target in the return target region.

In one embodiment, when the return target where the return target region is located is in a moving state, the aircraft returns according to the location of the return target region, determined by the time and the phase when the return signal is received. Because the return target also moves during the return of the aircraft, the aircraft returns to the determined location of the return target region, not the location of the remote control terminal on the return target. At this time, when the aircraft flies to the location of the return target region, a display screen of the mobile terminal will prompt “arrived at the location of the return target region, and please confirm whether to land”, and the display interface will display “Yes” and “No” buttons. At this time, the user can click “No”, and the aircraft will re-determine the current distance between the aircraft and the remote control terminal according to the wireless signal corresponding to the control command sent by the remote control terminal, and fly to the location above the return target where the remote control terminal is located.

It should be noted that, in order to ensure the matching accuracy between the image of the region where the aircraft is currently located and the pre-collected image of the return target region, before matching the image of the current region of the aircraft with the pre-collected image of the return target region, it is necessary to roughly calculate the distance between the aircraft and the return target in the return target region. If the distance between the aircraft and the return target is less than a preset distance threshold, the ground camera on the aircraft is started to shoot an image of a location below the region where the aircraft is currently located, and match with the pre-collected image of the return target region, so as to finely adjust the flight parameters of the aircraft according to the matching result, so that the aircraft can accurately land at the return target in the return target region.

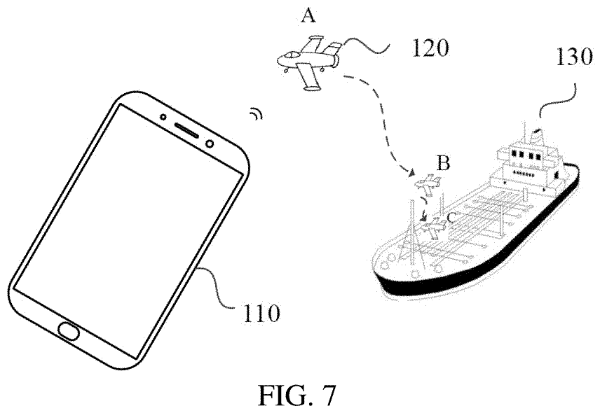

FIG. 7 is a schematic diagram of display of controlling an aircraft to accurately land at a return target provided by an embodiment of the present invention. As shown in FIG. 7, it is assumed that the return target is the yacht 130, the current location of the aircraft 120 is region A, the return target region is region B, and the return target is point C. Specifically, through the return signal sent by the remote control terminal 110, when the aircraft is controlled to fly from the region A to the top of the region B, the ground camera of the aircraft is started to shoot the image of the region where the aircraft is currently located, and the image of the current region is matched with the pre-shot image of the return target region. Because the return target is also in a moving state when the aircraft is in the process of matching the images, it can be understood that the current location of the aircraft has a certain distance from the return target. The relative speed and attitude angle of the aircraft are obtained through an image matching algorithm, so that the aircraft can accurately land at the return target, namely point C.

In the technical solution of this embodiment, the location of the return target region is roughly calculated according to the time and the phase of the return signal, so as to ensure that the aircraft can return to the location above the return target region. When the aircraft flies to the return target region, according to the matching result between the image of the current region and the pre-collected image of the return target region, the flight parameters are adjusted to land at the return target. The present invention solves the technical problem in the prior art that the aircraft cannot be accurately landed at the return target due to the movement of the return target, and achieves the technical effect of controlling the aircraft to accurately and safely land at the return target on the return target region.

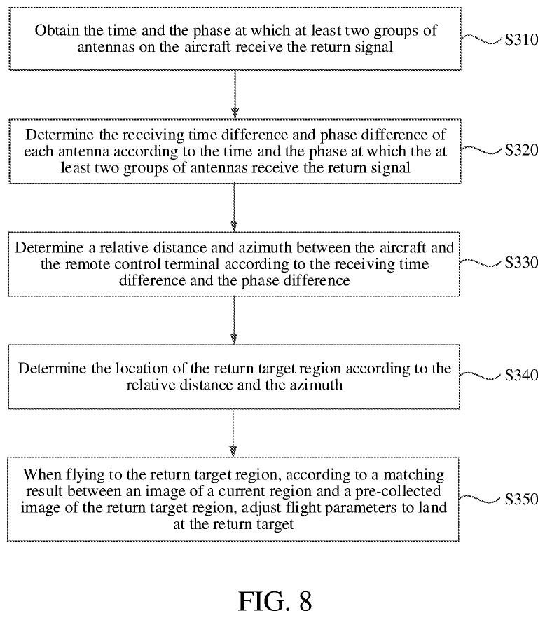

On the basis of the above embodiment, step S210 is further described in detail. FIG. 8 is a flow chart of another aircraft return control method provided by an embodiment of the present invention. It should be noted here that during the flight of the aircraft, when the GPS signal of the aircraft or the remote control terminal is poorly positioned, or the positioning error of one end is very large (generally, the GPS of the remote control terminal is lost), the distance between the aircraft and the remote control terminal can be roughly calculated through the time and the phase of the return signal to roughly determine the location of the return target region.

Specifically, referring to FIG. 8, the method specifically includes the following steps:

S310. Obtaining the time and the phase at which at least two groups of antennas on the aircraft receive the return signal.

It should be noted here that each aircraft may be provided with n groups of antennas, wherein n=2, 3 or 4. Moreover, each group of antennas needs to be installed on a fuselage or landing gear of the aircraft. It can be understood that when the aircraft receives the signal from the remote control terminal, the time and the phase at which the signal is received by each group of antennas will be different. In the embodiment, taking the signal sent by the remote control terminal as the return signal as an example, the determination of the location of the return target region according to the time and the phase of the signal will be described. Of course, a radio frequency unit is provided on the aircraft, and the radio frequency unit is used to receive and transmit radio wave signals to realize mutual conversion between radio waves and electrical signals, thereby realizing wireless communication between the aircraft and the remote control terminal. The radio frequency unit can receive and transmit the radio wave signals through the antennas on the fuselage or landing gear of the aircraft.

S320. Determining the receiving time difference and phase difference of each antenna according to the time and the phase at which the at least two groups of antennas receive the return signal.

The receiving time difference refers to a time difference value between at least two groups of antennas on the same aircraft in receiving the return signal; and the phase difference refers to a phase difference value between at least two groups of antennas on the same aircraft in receiving the return signal. In the embodiment, a different of the time at which a pair of antennas receives the return signal is made to obtain the receiving time difference; and a difference of the phases at which a pair of antennas receives the return signal is made to obtain the phase difference between the two.

S330. Determining a relative distance and azimuth between the aircraft and the remote control terminal according to the receiving time difference and the phase difference.

In the embodiment, the locations of each group of antennas on the aircraft are different, and accordingly, the time and the phase of receiving the return signal will be different. The relative distance and the azimuth between the aircraft and the remote control terminal are determined by using the time different and the phase difference of receiving the return signal by each group of antennas based on the distance difference value between each group of antennas and the frequency of the radio waves corresponding to the return signal transmitted by the remote control terminal.

S340. Determining the location of the return target region according to the relative distance and the azimuth.

In the embodiment, when the GPS positioning system of the aircraft does no fails, the aircraft can measure own longitude and latitude through the own GPS positioning system, and then can obtain the longitude and the latitude of the remote control terminal, that is, the latitude and longitude corresponding to the location of the return target region, through the latitude and longitude of the aircraft and the determined relative relationship and azimuth between the aircraft and the remote control terminal.

S350. When flying to the return target region, according to a matching result between an image of a current region and a pre-collected image of the return target region, adjusting flight parameters to land at the return target

In the technical solution of the embodiment, the time and the phase of receiving the return signal by at least two groups of antennas on the aircraft are obtained, and the receiving time difference and phase difference of each antenna are determined according to the time and phase of the at least two groups of antennas to receive the return signal, to determine the relative distance and azimuth between the aircraft and the remote control terminal, so as to determine the location of the return target region, thereby achieving the technical effect of roughly calculating the location of the return target region when the GPS positioning system of the remote control terminal fails.

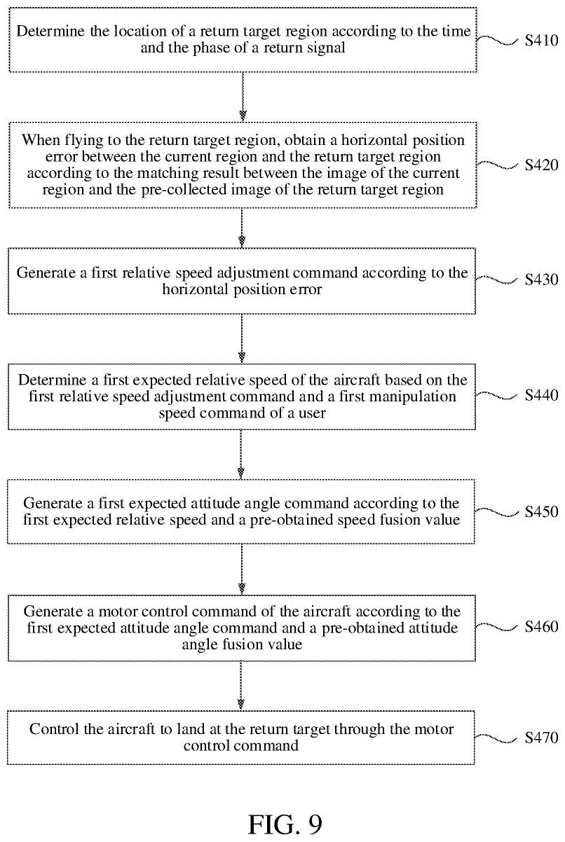

On the basis of the above embodiments, the adjustment of the flight parameters according to the matching result between the image of the current region and the pre-collected image of the return target region will be further described in detail. FIG. 9 is a flow chart of another aircraft return control method provided by an embodiment of the present invention. Referring to FIG. 9, the method specifically includes the following steps:

S410: Determining the location of a return target region according to the time and the phase of a return signal.

S420. When flying to the return target region, obtaining a horizontal position error between the current region and the return target region according to the matching result between the image of the current region and the pre-collected image of the return target region.

The horizontal error position refers to a distance difference between the location of the aircraft in the X direction corresponding to the current region and the location in the X direction of the return target region. It should be noted here that when the image shooting unit in the aircraft is started to collect the images at the location below the current region, it indicates that the aircraft has reached the preset range of the return target. At this time, the horizontal position error between the current region and the return target in the return target region can be obtained directly through the matching result between the image of the current region and the pre-collected image of the return target region.

S430. Generating a first relative speed adjustment command according to the horizontal position error.

The first relative speed adjustment command refers to the flight speed of the aircraft relative to the mobile vehicle determined according to the horizontal position error between the current region of the aircraft and the return target region, and the moving speed of the mobile vehicle. In the embodiment, after obtaining the horizontal position error between the current region of the aircraft and the return target in the return target region, the horizontal position error is input into a pre-established position controller, and the position controller calculates the flight speed of the aircraft relative to the mobile vehicle, so that the first relative speed adjustment command is generated according to the flight speed.

S440. Determining a first expected relative speed of the aircraft based on the first relative speed adjustment command and a first manipulation speed command of a user.

The first operation speed command refers to a command for the user to control the own flight speed through a lever mapping module in the remote controller corresponding to the aircraft. In the embodiment, the aircraft can adjust the speed of the aircraft through the first relative speed adjustment command generated by the position controller, or adjust the speed of the aircraft through the first operation speed command generated by the lever mapping module in the remote controller connected to the aircraft, to obtain the first expected relative speed of the aircraft. The first expected relative speed may be understood as the sum of the first relative speed corresponding to the first relative speed adjustment command and the first operation speed corresponding to the first operation speed command. For example, the first relative speed corresponding to the first relative speed adjustment command is 1 m/s, and the direction is a due north direction. If the first operation speed corresponding to the first operation speed command is 0.5 m/s, and the direction is the due north direction, then the first expected relative speed is 1.5 m/s, and the direction is the due north direction. Correspondingly, if the direction of the first relative speed corresponding to the first relative speed adjustment command is opposite to the direction of the first operation speed corresponding to the first operation speed command, the direction in which the absolute value of the speed between the first relative speed and the first operation speed is larger shall prevail.

S450. Generating a first expected attitude angle command according to the first expected relative speed and a pre-obtained speed fusion value.

It should be noted here that, in order to facilitate the acquisition of the parameters of the aircraft, a satellite navigation module, an accelerometer, a gyroscope and a magnetometer are configured on the aircraft. The satellite navigation module is used to measure the position and the speed of the aircraft. The accelerometer is used to measure the acceleration of the aircraft. The gyroscope is used to measure the angular velocity of the aircraft. The magnetometer is used to measure the heading angle of the aircraft. In the embodiment, the speed fusion value refers to the flight speed of the aircraft measured according to the satellite navigation module and the accelerometer. It can be understood that the speed fusion value is the flight speed obtained theoretically; and the first expected relative speed is the flight speed obtained by manual adjustment of the user according to the actual situation. Then, the first expected relative speed and the speed fusion value are input into a speed controller to generate the expected attitude angle command. The attitude angle is also called Euler angle, which is determined by the relationship between a body coordinate system and a geographic coordinate system and represented by three Euler angles of a heading angle, a pitch angle and a roll angle. For the process of obtaining the attitude angle according to the speed, reference may be made to the prior art, and details are not repeated here.

S460. Generating a motor control command of the aircraft according to the first expected attitude angle command and a pre-obtained attitude angle fusion value.

The motor control command is a command carrying the first expected relative speed and the expected attitude angle. In the embodiment, the attitude angle fusion value is a theoretical attitude angle determined by the gyroscope and the magnetometer. The expected attitude angle corresponding to the expected attitude angle command and the attitude angle fusion value are input into the attitude control system to generate the motor control command of the aircraft. The motor control command is a motor PWM command.

S470. Controlling the aircraft to land at the return target through the motor control command.

In the embodiment, the flight of the aircraft is controlled by the motor control command, so that the aircraft can accurately land at the return target.

It should be noted here that the speed fusion value and the attitude angle fusion value are both the fusion speed and attitude angle fusion values obtained by inputting the measured aircraft location, speed, acceleration, angular velocity and heading angle into a data fusion system, and are provided to a controller corresponding to the aircraft (for example, a position controller, a speed controller and an attitude control system), so that the controller generates corresponding control commands.

On the basis of the above embodiments, the control mode for landing at the return target will be described specifically. The location can be adjusted through two modes, so that the aircraft can accurately land at the return target.

In one embodiment, the control mode for landing at the return target includes:

S10. During the landing of the aircraft, obtaining a position deviation between the aircraft and the center of a landing point in the return target region in real time.

The image of the current region of the aircraft is collected by the image shooting unit on the aircraft, and the image of the current region and the image of the return target region are matched to obtain the position deviation between the aircraft and the center of the landing point in the return target region.

S20. Generating a second relative speed adjustment command of the aircraft according to the position deviation.

The second relative speed adjustment command refers to an adjustment command for the speed of the aircraft relative to the return target during the descent. It should be understood that during the descent of the aircraft, if the GPS of the remote control terminal is lost, in order to ensure that the aircraft can accurately land at the return target, the ground camera on the aircraft needs to be started, and a locking state between the aircraft and the center of the landing point in the return target region is maintained. At the same time, the position deviation between the aircraft and the center of the landing point in the return target region is input into the position controller to generate a second relative speed adjustment command.

S30. Determining a second expected relative speed of the aircraft according to the second relative speed adjustment command and a second manipulation speed command of the user.

The second operation speed command is a speed adjustment command generated by the user for operating the stick through the remote controller during the descent of the aircraft. For the process of determining the second expected relative speed according to the second relative speed corresponding to the second relative speed adjustment command and the second operation speed corresponding to the second operation speed command, reference may be made to the process of determining the first expected relative speed in the above embodiment, and will not be repeated here.

S40. Controlling the aircraft to land at the return target according to the second expected relative speed.

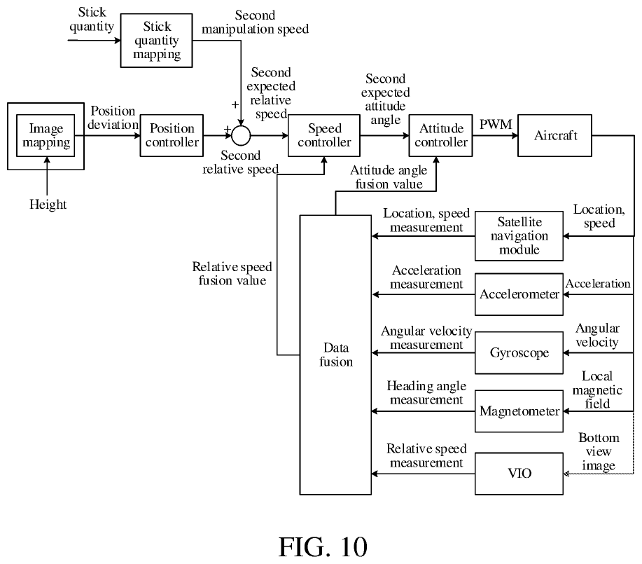

FIG. 10 is a flow chart of return control during landing of an aircraft provided by an embodiment of the present invention. As shown in FIG. 10, during the landing of the aircraft, if the GPS of the remote control terminal is lost, the ground camera on the aircraft needs to keep the target in the locking state, and the position deviation of the aircraft relative to the center of the landing point is obtained in real time through the image matching algorithm. This position deviation is input to a position controller to generate the second relative speed adjustment command. In addition, Visual-Inertial Odometry (VIO) can calculate the relative speed of the aircraft through the following image shot by the ground camera, and then fuse the relative speed with other sensors to obtain the relative speed fusion value. The second operation speed corresponding to the second manipulation speed command of the user for operating the stick is added with the second relative speed corresponding to the second relative speed adjustment command to obtain the second expected relative speed, and the second expected relative speed and the relative speed fusion value are input into a speed controller to generate the second expected attitude angle. Then, the second expected attitude angle and the attitude angle fusion value are input into an attitude control system to generate the PWM command of the motor to control the flight of the aircraft.

In one embodiment, the control mode for landing at the return target includes:

S1. During the landing of the aircraft, obtaining the position deviation between the aircraft and the center of the landing point in the return target region in real time.

S2. Generating a third relative speed adjustment command of the aircraft according to the position deviation.

S3. Determining a third expected relative speed of the aircraft according to the third relative speed adjustment command and the second manipulation speed command of the user.

S4. Controlling the aircraft to land at the return target according to the third expected relative speed.

It should be noted here that the specific implementation processes of steps S1-S4 are the same as those of steps S10-S40 in the above embodiment, and will not be repeated here. The only difference is that during the descent of the aircraft, the GPS positioning system of the aircraft and the GPS positioning system of the remote control terminal fail at the same time, or the GPS positioning system of the aircraft fails. At this time, the image shooting unit on the aircraft needs to use the image matching method to locate the return target on the return target, so as to ensure that the aircraft is accurately landed at the return target.

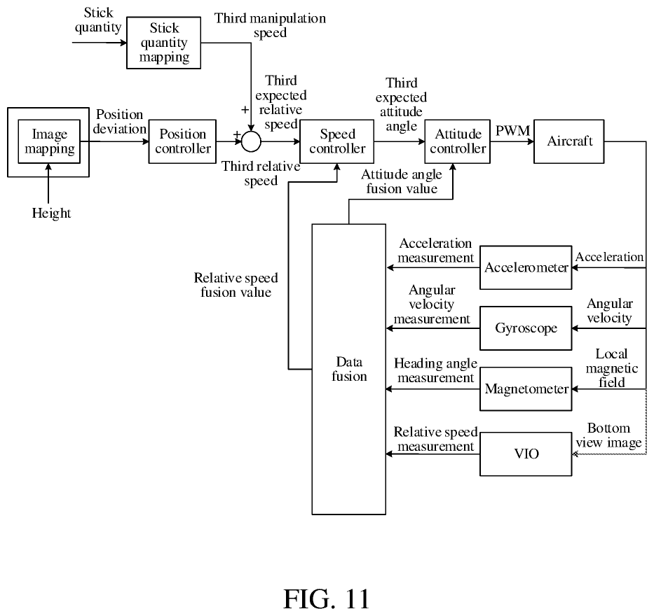

FIG. 11 is a flow chart of another return control during landing of an aircraft provided by an embodiment of the present invention. As shown in FIG. 11, during the descent, the GPS of the aircraft is lost, or both GPS are lost. At this time, the ground camera on the aircraft needs to keep the target in the locking state, and the image matching algorithm is used to obtain the position deviation of the aircraft relative to the center of the landing point in real time, and this position deviation is input into the position controller to generate the third relative speed adjustment command, and finally to obtain the PWM command of the motor. The process of generating the PWM command through the third relative speed adjustment command can be found in the description of FIG. 10 in the above embodiment, and will not be repeated here. The difference is that because the aircraft has no GPS speed measurement, the relative speed measured by the VIO becomes particularly important. It can be understood that when the VIO fails, the aircraft stops descending immediately; and when the VIO does not fail, the aircraft can be accurately landed at the return target through the solution in FIG. 11.

It should be noted here that, in the descending process, due to the inertia of the aircraft, in order to prevent the aircraft from failing during descending, the descending speed of the aircraft can be limited according to the current flight altitude of the aircraft. Specifically, on the basis of the above embodiment, the return control method of the aircraft further includes: obtaining the current flight altitude of the aircraft in real time during the landing of the aircraft; and adjusting the descent speed of the aircraft according to the current flight altitude and the preset altitude threshold.

The current flight altitude refers to the current height of the aircraft from the ground. In order to facilitate the statistics of the flight height of the aircraft, the current flight height of the aircraft is calculated directly with the ground as a reference. Of course, a certain region on different mobile vehicles can also be used as a reference to count the current flight height of the aircraft. In order to prevent the aircraft from causing damage to personnel and the own hardware of the aircraft during the descent, the current flight altitude of the aircraft is obtained in real time to adjust the descent speed of the aircraft according to the comparison result between the flight altitude and the altitude threshold. Of course, multiple altitude thresholds can be set for the aircraft, and different descent speeds can be set in different altitude ranges. Exemplarily, when the altitude of the aircraft is greater than 10 m, the maximum descending speed is limited to 5 m/s; when the altitude of the aircraft is not greater than 10 m, but greater than 3 m, the maximum descending speed is limited to 2 m/s; when the altitude of the aircraft is not greater than 3 m, but greater than 0.5 m, the maximum descending speed is limited to 0.5 m/s; and when the altitude of the aircraft is not greater than 0.5 m, the maximum descending speed is limited to 0.2 m/s.

Of course, in the actual operation process, the altitude threshold of the aircraft and the corresponding descent speed in different altitude ranges can be set according to the actual situation of the mobile vehicle.

It should be noted here that during the flight of the aircraft, the wind will increase. In order to ensure the safety of the personnel below the aircraft, the return altitude of the aircraft can be set. Specifically, before flight to the return target region, the method further includes: obtaining the current flight altitude when receiving the return signal; determining whether the current flight altitude reaches a preset return safety altitude; and adjusting the current flight altitude of the aircraft to the return safety altitude if the return safety altitude is not reached, so that the aircraft flies at the return safety altitude.

During the actual operation, the return safety altitude can be set according to the actual situation. For example, if the aircraft lands in an open space, the return safety altitude can be set to be relatively low; and if the aircraft flies and lands on a sea with many people, in order to ensure the safety of personnel, the return safety altitude can be set to be relatively high. Of course, in general, the return safety altitude is at least more than 10 m.

In the embodiment, the safety altitude protection strategy of the aircraft is described by taking the return safety altitude of 30 m as an example. It can be understood that during return of the aircraft, the return safety altitude needs to be greater than 30 m. When the aircraft receives a return signal, if the current flight altitude of the aircraft is lower than 30 m, the aircraft needs to climb to 30 m before performing the above return logic; and if the aircraft is higher than 30 m, the aircraft can return at the current altitude.

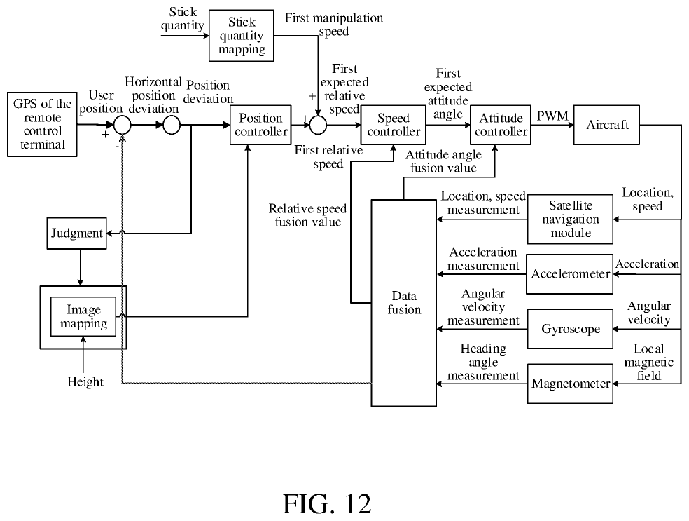

FIG. 12 is a flow chart of an aircraft return control method when GPS signals of an aircraft and a remote control terminal are good provided by an embodiment of the present invention. As shown in FIG. 12, when the aircraft takes off, the images of the deck during takeoff are recorded according to different altitudes. When the aircraft returns, the GPS position (user position) of the remote control terminal is obtained in real time, and used as a target point that the aircraft needs to track, and the difference is made with the position fusion value of the aircraft to obtain a rough position error. The rough error is judged. If the distance is greater than 2 m, a judgment module outputs 0, and the image matching function is turned off. At this time, the aircraft starts to return according to the user position, and flies to location above the user position (that is, the remote control terminal). If the distance is less than or equal to 2 m, the judgment module outputs 1, and the visual image matching is turned on for accurate landing. At this time, the image matching module performs image matching according to the altitude, and outputs the horizontal position error. The horizontal position error is input into the position controller to generate the first relative speed adjustment command. At the same time, the stick information of the remote controller is obtained through a stick quantity mapping module in the remote controller wirelessly connected to the aircraft, and the corresponding first manipulation speed command is generated according to pre-established corresponding rules. Then, the first relative speed corresponding to the first relative speed adjustment command and the first operation speed corresponding to the first manipulation speed command are summed to obtain the first expected relative speed, and the first expected relative speed and the speed fusion value are input into the speed controller to generate the first expected attitude angle command. The first expected attitude angle command and the attitude angle fusion value are input to the attitude control system to generate the PWM command of the motor to control the flight of the aircraft. The satellite navigation module obtains the position and speed of the aircraft; the accelerometer measures the acceleration of the aircraft; the gyroscope measures the angular velocity of the aircraft; and the magnetometer measures the heading angle of the aircraft according to the local magnetic field. Then, the measured position, speed, acceleration, angular velocity and heading angle are input into a data fusion system, and the speed fusion value, position fusion value and attitude fusion value are output and provided to the control system of the aircraft.

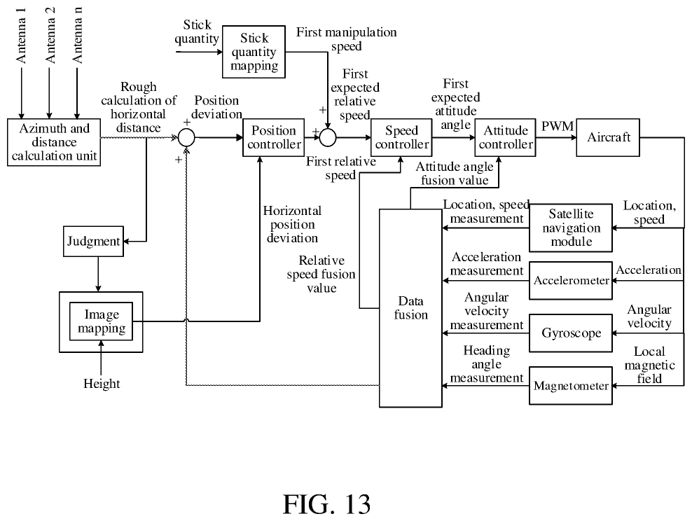

FIG. 13 is a flow chart of an aircraft return control method when GPS signals of an aircraft and a remote control terminal are bad provided by an embodiment of the present invention. It should be noted that during return of the aircraft (horizontal flight), when one end of the GPS signals at both ends of the aircraft and the remote controller/App has poor positioning, or one end has a large positioning error (generally, the GPS on the remote control terminal is often lost), the method of returning is as follows: as shown in FIG. 13, n groups of antennas are arranged on the aircraft, generally n=2,3,4. These groups of antennas are installed on the fuselage or landing gear of the aircraft, and the installation positions are different to some extent. It can be understood that the times and phases of the radio wave signals received by different antennas are different for the radio wave signals sent from the remote control terminal. The time difference and the phase difference of the antennas can be used to calculate the relative distance and azimuth between the aircraft and the remote control terminal. If GPS positioning of the remote control terminal is inaccurate, this solution can be adopted to ensure that the aircraft can return above the return target such as yachts in a moving state. If the aircraft returns above the return target, the visual function of the aircraft can be activated to match the image of the current region of the aircraft with the image of the return target region for accurate landing.

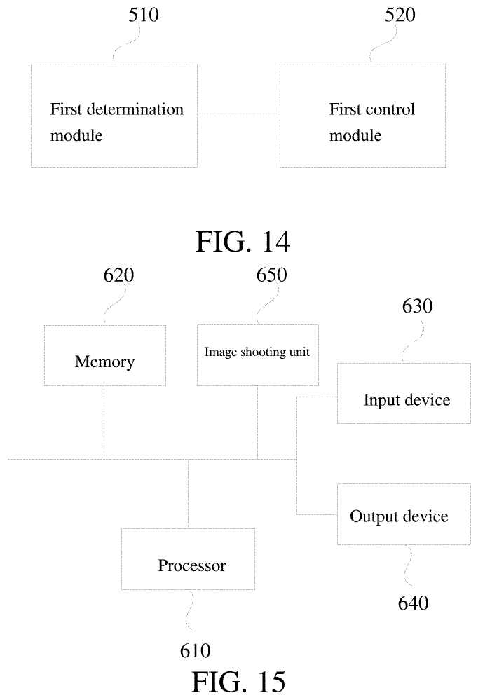

FIG. 14 is a structural block diagram of an aircraft return control device provided by an embodiment of the present invention. Referring to FIG. 14, the device includes: a first determination module 510 and a first control module 520.

The first determination module 510 is used to determine the location of the return target region according to the time and the phase of the return signal.

The first control module 520 is used for adjusting flight parameters according to a matching result between an image of a current region and a pre-collected image of the return target region when flying to the return target region, to land at the return target.

In the technical solution of the embodiment, the location of the return target region is roughly calculated according to the time and the phase of the return signal, so as to ensure that the aircraft can return above the return target region. When the aircraft flies to the return target region, according to the matching result between the image of the current region and the pre-collected image of the return target region, the flight parameters are adjusted to land at the return target. The present invention solves the technical problem in the prior art that the aircraft cannot be accurately landed at the return target due to the movement of the return target, and achieves the technical effect of controlling the aircraft to accurately and safely land at the return target on the return target region.

On the basis of the above embodiment, the first determination module includes:

an obtaining unit, used for obtaining the time and the phase at which at least two groups of antennas on the aircraft receive the return signal;

a first determination unit, used for determining the receiving time difference and phase difference of each antenna according to the time and the phase at which the at least two groups of antennas receive the return signal;

a second determination unit, used for determining a relative distance and azimuth between the aircraft and the remote control terminal according to the receiving time difference and the phase difference;

a third determination unit, used for determining the location of the return target region according to the relative distance and the azimuth.

On the basis of the above embodiment, adjustment of the flight parameters according to the matching result between the image of the current region and the pre-collected image of the return target region is specifically used for:

obtaining a horizontal position error between the current region and the return target region according to the matching result between the image of the current region and the pre-collected image of the return target region;

generating a first relative speed adjustment command according to the horizontal position error;

determining a first expected relative speed of the aircraft based on the first relative speed adjustment command and a first manipulation speed command of a user;

generating a first expected attitude angle command according to the first expected relative speed and a pre-obtained speed fusion value;

generating a motor control command of the aircraft according to the first expected attitude angle command and a pre-obtained attitude angle fusion value, wherein the motor control command is a command carrying the first expected relative speed and the first expected attitude angle.

On the basis of the above embodiment, the control mode for landing at the return target includes: during the landing of the aircraft, obtaining the position deviation between the aircraft and the center of the landing point in the return target region in real time; generating a second relative speed adjustment command of the aircraft according to the position deviation; determining a second expected relative speed of the aircraft according to the second relative speed adjustment command and a second manipulation speed command of the user; and controlling the aircraft to land at the return target according to the second expected relative speed.

On the basis of the above embodiment, the control mode for landing at the return target includes: during the landing of the aircraft, obtaining the position deviation between the aircraft and the center of the landing point in the return target region in real time; generating a third relative speed adjustment command of the aircraft according to the position deviation; determining a third expected relative speed of the aircraft according to the third relative speed adjustment command; and controlling the aircraft to land at the return target according to the third expected relative speed.

On the basis of the above embodiment, the aircraft return control device further includes:

a first obtaining module for obtaining the current flight altitude of the aircraft in real time during the landing of the aircraft;

a first adjustment module for adjusting the descent speed of the aircraft according to the current flight altitude and the preset altitude threshold.

On the basis of the above embodiment, the aircraft return control device further includes:

a second obtaining module for obtaining the current flight altitude when receiving the return signal before flight to the return target region;

a second determination module for determining whether the current flight altitude reaches the preset return safety altitude;

a second adjustment module for adjusting the current flight altitude of the aircraft to the return safety altitude if the return safety altitude is not reached, so that the aircraft flies at the return safety altitude.

The above aircraft return control device can execute the aircraft return control method provided by any embodiment of the present invention, and has functional modules and beneficial effects corresponding to the execution method.

FIG. 15 is a schematic diagram of a hardware structure of an aircraft provided by an embodiment of the present invention. Referring to FIG. 15, an aircraft provided by an embodiment of the present invention includes: a processor 610, a memory 620, an input device 630, an output device 640 and an image shooting unit 650. The number of processors 610 in the aircraft may be one or more. In FIG. 15, one processor 610 is taken as an example. The processor 610, the memory 620, the input device 630, the output device 640 and the image shooting unit 650 in the aircraft can be connected through a bus or other ways. In FIG. 15, the connection through the bus is taken as an example.

The memory 620 in the aircraft, as a computer-readable storage medium, can be used to store one or more programs, and the programs can be software programs, computer-executable programs and modules, such as program instructions/modules corresponding to the aircraft return control method provided by the embodiments of the present invention (for example, the modules in the aircraft return control device shown in FIG. 14 include: a first determination module 510 and a first control module 520). The processor 610 executes various functional applications and data processing of the aircraft by running the software programs, instructions and modules stored in the memory 620, thereby realizing the aircraft return control method in the above method embodiments.

The memory 620 may comprise a storage program region and a storage data region, wherein the storage program region may store an operating system and at least one application program required by the functions; and the storage data region may store data and the like created according to the use of terminal equipment. In addition, the memory 620 may comprise a high-speed random access memory and a nonvolatile memory, such as at least one magnetic disk storage device, flash memory device, or other non-volatile solid-state storage device. In some embodiments, the memory 620 may further include memories located remotely from the processor 610, and these remote memories may be connected to the device through a network. Examples of the above network include, but are not limited to, the Internet, an Intranet, a local area network, a mobile communication network and combinations thereof.

The input device 630 can be used to receive numerical or character information input by the user, so as to generate key signal input related to user setting and function control of a terminal device. The output device 640 may include a display device such as a display screen. The image shooting unit 650 is used for shooting the image of the current region of the aircraft, and sending the shot image to the memory 620 for storage. The image shooting unit 650 may be a main camera of the aircraft, or may be an independent ground camera.

Furthermore, when one or more programs included in the above aircraft are executed by one or a plurality of processors 610, the programs perform the following operation: determining the location of the return target region according to the time and the phase of the return signal; and adjusting flight parameters according to a matching result between an image of a current region and a pre-collected image of the return target region when flying to the return target region, to land at the return target.

Embodiments of the present invention further provide a computer-readable storage medium, on which a computer program is stored, and when the program is executed by the processor, the aircraft return control method provided by the embodiments of the present invention is realized. The method includes: determining the location of the return target region according to the time and the phase of the return signal; and adjusting flight parameters according to a matching result between an image of a current region and a pre-collected image of the return target region when flying to the return target region, to land at the return target.

The computer storage medium in the embodiments of the present invention may adopt any combination of one or more computer-readable media. The computer-readable medium may be a computer-readable signal medium or a computer-readable storage medium. The computer-readable storage medium can be, for example, but not limited to, an electrical, magnetic, optical, electromagnetic, infrared, or semiconductor system, apparatus or device, or a combination of any of the above. More specific examples (non-exhaustive list) of the computer readable storage media include: electrical connection having one or more wires, portable computer disks, hard disks, random access memory (RAM), read only memory (ROM), erasable programmable read only memory (EPROM or flash memory), optical fiber, portable compact disk read only memory (CD-ROM), optical storage device, magnetic storage device, or any suitable combination of the above. Herein, the computer-readable storage medium may be any tangible medium that contains or stores a program that can be used by or in conjunction with a command execution system, apparatus or device.

The computer-readable signal medium may include propagated data signals in baseband or as part of a carrier wave, which carry computer-readable program codes. The propagated data signals may be in multiple forms, including but not limited to electromagnetic signals, optical signals, or any suitable combination of the above. The computer-readable signal medium can also be any computer-readable medium other than the computer-readable storage medium. The computer-readable storage medium can transmit, propagate, or transport the programs used by or in connection with the command execution system, apparatus or device.

The program codes included on the computer-readable medium may be transmitted using any suitable medium, including—but not limited to wireless, wire, optical fiber cable, RF, etc., or any suitable combination of the above.

Computer program codes for carrying out operation of the present invention may be written in one or more programming languages or combination. The programming languages include object-oriented programming languages, such as Java, Smalltalk and C++, and also include conventional procedural programming languages, such as “C” language or similar programming language. The program codes may be executed entirely on a user computer, partly on the user computer, as a stand-alone software package, partly on the user computer and partly on a remote computer, or entirely on a remote computer or server. In the case of the remote computer, the remote computer may be connected to the user computer through any kind of network, including a local area network (LAN) or a wide area network (WAN), or may be connected to an external computer (such as, through Internet using an Internet service provider).

It should be noted that the above are only preferred embodiments of the present invention and applied technical principles. Those skilled in the art will understand that the present invention is not limited to the specific embodiments described herein, and various obvious changes, readjustments and substitutions can be made by those skilled in the art without departing from the protection scope of the present invention. Therefore, although the present invention is described in detail through the above embodiments, the present invention is not limited to the above embodiments, and can also include more other equivalent embodiments without departing from the concept of the present invention. The scope of the present invention is determined by the scope of the appended claims.

1. An aircraft return control method, comprising:
determining the location of a return target region according to the time and the phase of a return signal;
when flying to the return target region, adjusting flight parameters according to a matching result between an image of a current region and a pre-collected image of the return target region, to land at the return target.

2. The method according to claim 1, wherein the determining the location of a return target region according to the time and the phase of a return signal comprises:
obtaining the time and the phase at which at least two groups of antennas on the aircraft receive the return signal;
determining a receiving time difference and a phase difference of each antenna according to the time and the phase at which the at least two groups of antennas receive the return signal;
determining a relative distance and an azimuth between the aircraft and a remote control terminal according to the receiving time difference and the phase difference;
determining the location of the return target region according to the relative distance and the azimuth.

3. The method according to claim 1, wherein the adjusting flight parameters according to a matching result between an image of a current region and a pre-collected image of the return target region comprises:
obtaining a horizontal position error between the current region and the return target region according to the matching result between the image of the current region and the pre-collected image of the return target region;
generating a first relative speed adjustment command according to the horizontal position error;
determining a first expected relative speed of the aircraft based on the first relative speed adjustment command and a first manipulation speed command of a user;
generating a first expected attitude angle command according to the first expected relative speed and a pre-obtained speed fusion value;
generating a motor control command of the aircraft according to the first expected attitude angle command and the pre-obtained attitude angle fusion value, wherein the motor control command is a command carrying the first expected relative speed and the first expected attitude angle.

4. The method according to claim 1, wherein a control mode for landing at the return target comprises:
obtaining a position deviation between the aircraft and the center of a landing point in the return target region in real time during the landing of the aircraft;
generating a second relative speed adjustment command of the aircraft according to the position deviation;
determining a second expected relative speed of the aircraft according to the second relative speed adjustment command and a second manipulation speed command of the user;
controlling the aircraft to land at the return target according to the second expected relative speed.

5. The method according to claim 1, wherein the control mode for landing at the return target comprises:
obtaining a position deviation between the aircraft and the center of a landing point in the return target region in real time during the landing of the aircraft;
generating a third relative speed adjustment command of the aircraft according to the position deviation;
determining a third expected relative speed of the aircraft according to the third relative speed adjustment command and the second manipulation speed command of the user;
controlling the aircraft to land at the return target according to the third expected relative speed.

6. The method according to claim 1, further comprising:
obtaining the current flight altitude of the aircraft in real time during the landing of the aircraft;
adjusting the descending speed of the aircraft according to the current flight altitude and a preset altitude threshold.

7. The method according to claim 1, further comprising, before flying to the return target region:
obtaining the current flight altitude when receiving the return signal;
determining whether the current flight altitude reaches a preset return safety altitude;
adjusting the current flight altitude of the aircraft to the return safety altitude if the return safety altitude is not reached, so that the aircraft flies at the return safety altitude.

8. An aircraft return control device, comprising:
one or a plurality of processors;
a memory, used for storing one or more programs;
an image shooting unit, used for shooting images;
when the one or more programs are executed by the one or a plurality of processors, causing the one or plurality of processors to:
determine the location of a return target region according to the time and the phase of a return signal;
when flying to the return target region, adjust flight parameters according to a matching result between an image of a current region and a pre-collected image of the return target region, to land at the return target.

9. The device according to claim 8, wherein the one or plurality of processors are further configured to:
obtain the time and the phase at which at least two groups of antennas on the aircraft receive the return signal;
determine a receiving time difference and a phase difference of each antenna according to the time and the phase at which the at least two groups of antennas receive the return signal;
determine a relative distance and an azimuth between the aircraft and a remote control terminal according to the receiving time difference and the phase difference;
determine the location of the return target region according to the relative distance and the azimuth.

10. The device according to claim 8, wherein the one or plurality of processors are further configured to:
obtained a horizontal position error between the current region and the return target region according to the matching result between the image of the current region and the pre-collected image of the return target region;
generate a first relative speed adjustment command according to the horizontal position error;
determine a first expected relative speed of the aircraft based on the first relative speed adjustment command and a first manipulation speed command of a user;
generate a first expected attitude angle command according to the first expected relative speed and a pre-obtained speed fusion value;
generate a motor control command of the aircraft according to the first expected attitude angle command and the pre-obtained attitude angle fusion value, wherein the motor control command is a command carrying the first expected relative speed and the first expected attitude angle.

11. The device according to claim 8, wherein the one or plurality of processors are further configured to:
obtain a position deviation between the aircraft and the center of a landing point in the return target region in real time during the landing of the aircraft;
generate a second relative speed adjustment command of the aircraft according to the position deviation;
determine a second expected relative speed of the aircraft according to the second relative speed adjustment command and a second manipulation speed command of the user;
control the aircraft to land at the return target according to the second expected relative speed.

12. The device according to claim 8, wherein the one or plurality of processors are further configured to:
obtain a position deviation between the aircraft and the center of a landing point in the return target region in real time during the landing of the aircraft;
generate a third relative speed adjustment command of the aircraft according to the position deviation;
determine a third expected relative speed of the aircraft according to the third relative speed adjustment command and the second manipulation speed command of the user;
control the aircraft to land at the return target according to the third expected relative speed.

13. The device according to claim 8, wherein the one or plurality of processors are further configured to:
obtain the current flight altitude of the aircraft in real time during the landing of the aircraft;
adjust the descending speed of the aircraft according to the current flight altitude and a preset altitude threshold.

14. The device according to claim 8, wherein the one or plurality of processors are further configured to:
obtain the current flight altitude when receiving the return signal;
determine whether the current flight altitude reaches a preset return safety altitude;
adjust the current flight altitude of the aircraft to the return safety altitude if the return safety altitude is not reached, so that the aircraft flies at the return safety altitude.

15. An aircraft, comprising:
one or a plurality of processors;
a memory, used for storing one or more programs;
an image shooting unit, used for shooting images;
when the one or more programs are executed by the one or a plurality of processors, causing the one or plurality of processors to:
determine the location of a return target region according to the time and the phase of a return signal;
when flying to the return target region, adjust flight parameters according to a matching result between an image of a current region and a pre-collected image of the return target region, to land at the return target.

16. The aircraft according to claim 15, wherein the one or plurality of processors are further configured to:
obtain the time and the phase at which at least two groups of antennas on the aircraft receive the return signal;
determine a receiving time difference and a phase difference of each antenna according to the time and the phase at which the at least two groups of antennas receive the return signal;
determine a relative distance and an azimuth between the aircraft and a remote control terminal according to the receiving time difference and the phase difference;
determine the location of the return target region according to the relative distance and the azimuth.

17. The aircraft according to claim 15, wherein the one or plurality of processors are further configured to:
obtained a horizontal position error between the current region and the return target region according to the matching result between the image of the current region and the pre-collected image of the return target region;
generate a first relative speed adjustment command according to the horizontal position error;
determine a first expected relative speed of the aircraft based on the first relative speed adjustment command and a first manipulation speed command of a user;
generate a first expected attitude angle command according to the first expected relative speed and a pre-obtained speed fusion value;
generate a motor control command of the aircraft according to the first expected attitude angle command and the pre-obtained attitude angle fusion value, wherein the motor control command is a command carrying the first expected relative speed and the first expected attitude angle.

18. The aircraft according to claim 15, wherein the one or plurality of processors are further configured to:
obtain a position deviation between the aircraft and the center of a landing point in the return target region in real time during the landing of the aircraft;
generate a second relative speed adjustment command of the aircraft according to the position deviation;
determine a second expected relative speed of the aircraft according to the second relative speed adjustment command and a second manipulation speed command of the user;
control the aircraft to land at the return target according to the second expected relative speed.

19. The aircraft according to claim 15, wherein the one or plurality of processors are further configured to:
obtain a position deviation between the aircraft and the center of a landing point in the return target region in real time during the landing of the aircraft;
generate a third relative speed adjustment command of the aircraft according to the position deviation;
determine a third expected relative speed of the aircraft according to the third relative speed adjustment command and the second manipulation speed command of the user;
control the aircraft to land at the return target according to the third expected relative speed.

20. The aircraft according to claim 15, wherein the one or plurality of processors are further configured to:
obtain the current flight altitude of the aircraft in real time during the landing of the aircraft;
adjust the descending speed of the aircraft according to the current flight altitude and a preset altitude threshold.

21. The aircraft according to claim 15, wherein the one or plurality of processors are further configured to:
obtain the current flight altitude when receiving the return signal;
determine whether the current flight altitude reaches a preset return safety altitude;
adjust the current flight altitude of the aircraft to the return safety altitude if the return safety altitude is not reached, so that the aircraft flies at the return safety altitude.
